(19) United States
(12) Patent Application Publication
(10) Pub. No.: US 2009/0037443 A1
(43) Pub. Date: Feb. 5, 2009

(54) INTELLIGENT GROUP COMMUNICATION

(75) Inventors: Anant ATHALE, Schaumburg, IL (US); Jay H. Acharya, Bartlett, IL (US); Kevin D. Bailey, South Elgin, IL (US); Rajarshi Chatterjee, Bartlett, IL (US); Michael Zhihe Jiang, Lake in the Hills, IL (US); Thomas M. Tirpak, Glenview, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/832,709

(22) Filed: Aug. 2, 2007

(51) Int. Cl. G06F 17/30

(52) U.S. Cl. 707/100; 707/E17.05

(57) ABSTRACT

A method, apparatus, and electronic device for hierarchical communications are disclosed. A connection interface may send and receive a data task. A database may store a group of contact nodes. A processor may select a sub-group of contact nodes from the group of contact nodes based upon the data task and create a hierarchical communications tree from the sub-group of contacts based on the data task.

### FIELD OF THE INVENTION

The present invention relates to a method and system for gathering and disseminating data between a group of users. The present invention further relates to using a hierarchical communications tree to gather data.

### INTRODUCTION

When seeking to gather and disseminate data from a group network containing many user experts, a user may seek to communicate on a one-on-one basis or a one-to-many, or broadcast, basis. The communications may be a text or voice message. Group communications may be integral to social networks where an individual user or device can simultaneously communicate with a group of users or devices. The current group communication systems may be based on “flat lists”, providing the same connectivity to all users, that are defined either statically, such as instant message groups, or dynamically, such as a selective dynamic group call for Motorola's Integrated Digital Enhanced Network (iDEN)®.

### SUMMARY OF THE INVENTION

A method, apparatus, and electronic device for hierarchical communications are disclosed. A connection interface may receive a data task. A database may store a group of contact nodes. A processor may select a sub-group of contact nodes from the group of contact nodes based upon the data task and create a hierarchical communications tree from the sub-group of contacts based on the data task.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one example of a hierarchical communications tree.

FIG. 2 illustrates in a block diagram one embodiment of a tree manager for hierarchical groups.

FIG. 3 illustrates in a block diagram one embodiment a design goal statement.

FIG. 4 illustrates in a flowchart one embodiment for a method of constructing a hierarchical communications tree.

FIG. 5 illustrates in one embodiment a method for adapting the hierarchical communications tree.

FIG. 6 illustrates one embodiment of a system for creating a hierarchical communications tree.

FIG. 7 illustrates one embodiment of a system for sending a text message using a hierarchical communications tree.

FIG. 8 illustrates a possible configuration of a computing system to act as a mobile telecommunications apparatus or electronic device to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, apparatus, and electronic device for hierarchical communications are disclosed. A connection interface may send and receive a data task. A database may store a group of contact nodes. A processor may select a sub-group of contact nodes from the group of contact nodes based upon the data task and create a hierarchical communications tree from the sub-group of contacts based on the data task.

The hierarchical group communication may be used to process a data task. A data task may be a request seeking an answer to a data query or data that needs to be disseminated to other key users in a network. The hierarchical group communication may arrange the users in a tree structure such that the original root node is the communication initiator. A communication message may propagate through other nodes based on the level of the node in the tree. The hierarchical group communication may be transmitted as a text message, a voice message, a multimedia message, or other message medium. The hierarchical group communication may be enabled by short message service (SMS) or multimedia messaging service (MMS) messaging for scenarios where text or multimedia messaging is preferred over voice.

Unlike the flat groups that contact all the nodes in a group, a hierarchical group may contact only the top-level node or nodes, propagating the communication to lower level nodes as required. The hierarchical group may optimize the call and network overhead associated with a group call. The communication may resume at the each contacted node and propagates further in the tree, instead of terminating on the contact node or nodes in a “flat list”. The hierarchical groups may be statically defined and maintained in a common directory accessible to all the nodes or may be dynamically published by the node that initiates or propagates the call. The hierarchical group may be dynamically formed based on the user specified criteria and contact node characteristics, rather than relying on the user selection of nodes required by the selective dynamic group call feature. The hierarchical group may be initially based on the organizational chart for the overall group. The hierarchical group may be continuously monitored for any data events, such as node timeout triggered by a failure of the contact node to respond after a given set of time. These data events may trigger adjustments to the tree, including tree regeneration, branch regeneration, the addition or removal of contact nodes, re-layout of the tree, and other tree adjustments. Due to reduced network overhead, the hierarchical groups may be scaled up or down depending upon the data task context.

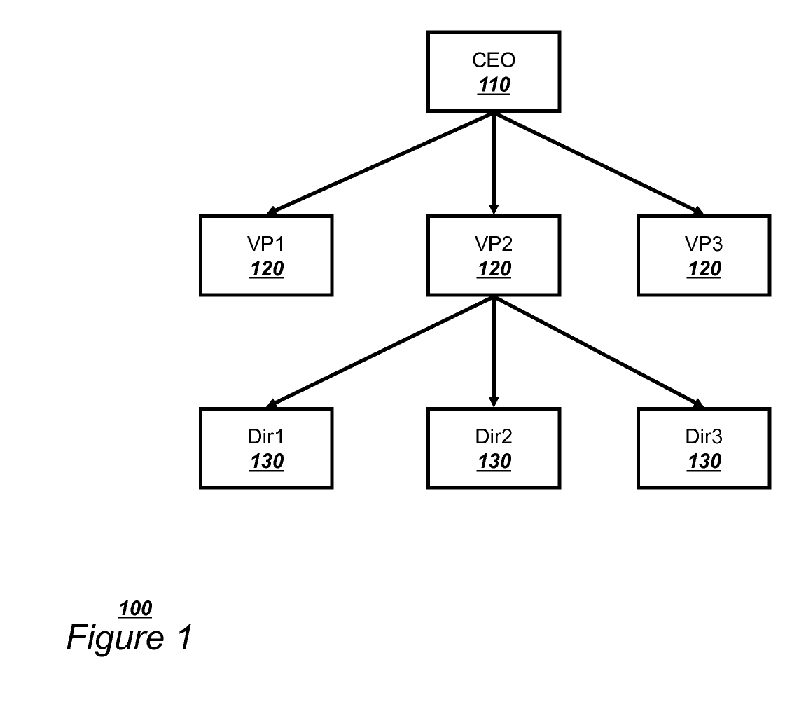

FIG. 1 illustrates in a block diagram one example of a hierarchical communications tree 100. In this example, the chief executive officer (CEO) 110 of a company may be looking for information about a certain technology. The CEO 110 may initiate a SMS query about this data task with a subservient officer 120, such as a vice president (VP), asking for information. The VPs in turn may initiate a SMS based search within the VPs' organizations if necessary to complete the given data task. The information may be made available by one of the nodes, such as a director 130 (Dir 3), under a VP 120 (VP2). The information may then be forwarded to the CEO 110 therefore completing the “search” process workflow.

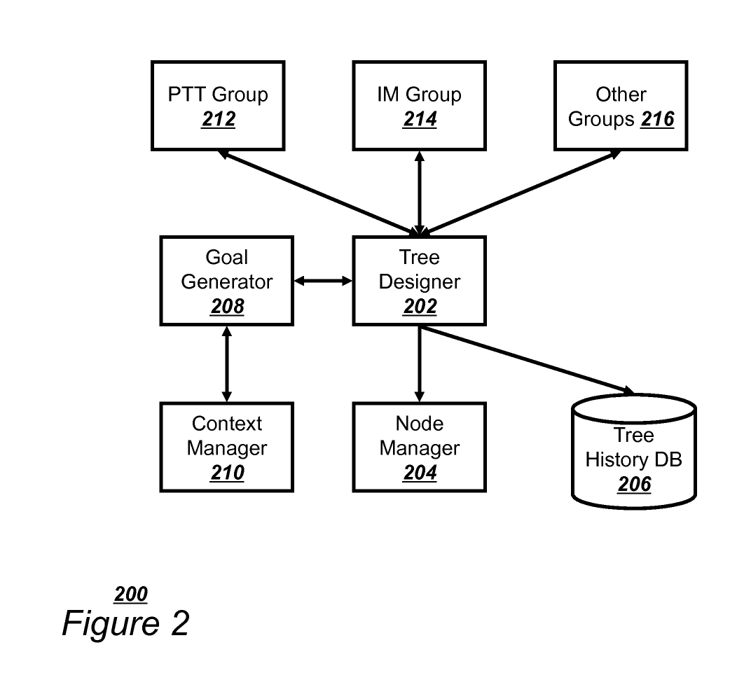

FIG. 2 illustrates in a block diagram one embodiment of a tree manager 200 for hierarchical groups. A tree designer 202 may use hierarchical groups defined manually by the user or generated dynamically based on the context of the data task to generate a hierarchical communications tree.

A node manager 204 may manage the various individual contact nodes that may be composed hierarchically by the tree designer 202. Each contact node may correspond to a single end-user device or service agent. The node manager 204 may maintain a node profile. The node profile may include the static information associated with the contact node, such as node address, phone number, IM address, or other node information. The node manager 204 may also maintain the node's dynamic properties, such as presence, location, or other dynamic properties. The node manager 204 may also dynamically manage the metadata associated with each node during a hierarchical group call. The node manager 204 may be the bridge between the method of managing the tree and the external application that is using the tree. The node manager 204 may have access to the continuously collected incremental knowledge from the nodes, related to the type of hierarchical group communication, such as a query about technology. External to or within the node manager 204 this knowledge is aggregated, using any one of the available automated knowledge management techniques, such as summarization. The node manager 204 may compute a score to reflect when is the communication is “done”. Such a score may reflect the level of confidence or sufficiency of information collected since the inception of a particular hierarchical group communication.

A tree history database (DB) 206 may maintain historical information associated with the hierarchical groups. This information may include the tree, or node graph, utilized for a given goal, the success rate associated with a given tree for a given goal, or other historical data regarding hierarchical communications trees. The tree designer 202 may utilize the historical information to dynamically generate new groups.

A goal generator 208 may utilize the context information of a data task to generate a specific goal statement used by the tree designer 202 to construct or adapt a tree. The goal statement may be either user defined or derived by the system based on the data task and the context of the data task, as determined by the context manager 210. The context of the data task may be the physical context, task originator context, or temporal context, such as a time of day, frequency, or temporal information.

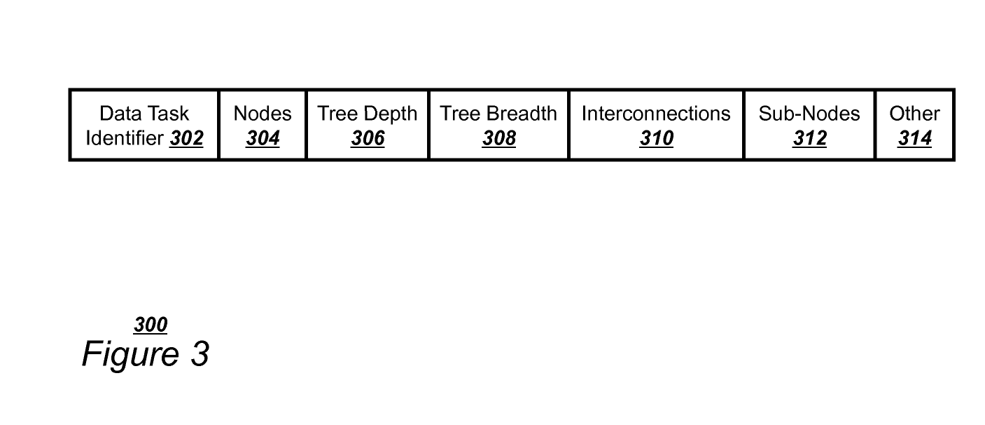

FIG. 3 illustrates in a block diagram one embodiment a design goal statement 300. A data task identifier 302 may identify the data task associated with the design goal statement. The design goal statement may include a set of tree criteria describing quantifiable characteristics of the tree structure and the nodes within the tree. The tree structure characteristics may be number of nodes 304, tree depth 306, tree breadth as measured at the lowest level 308, total number of interconnections 310, average number of sub-nodes connected to a root node 312, and other tree structure characteristics 314. The tree nodal characteristics may be number of acknowledged subject matter experts (SMEs), number of times that a node has responded within time to a given query, and other tree nodal characteristics.

The tree designer 202 may generate a hierarchical communications tree based on the design goals provided by the goal generator 208. The tree designer 202 may use available nodes from the node manager 204. The available contact nodes may be from a push to talk (PTT) group 212, an instant messaging (IM) group 214, or other communications group 216. The tree designer 202 may reuse a tree from the tree history database 206 or construct a new one based on the design goal.

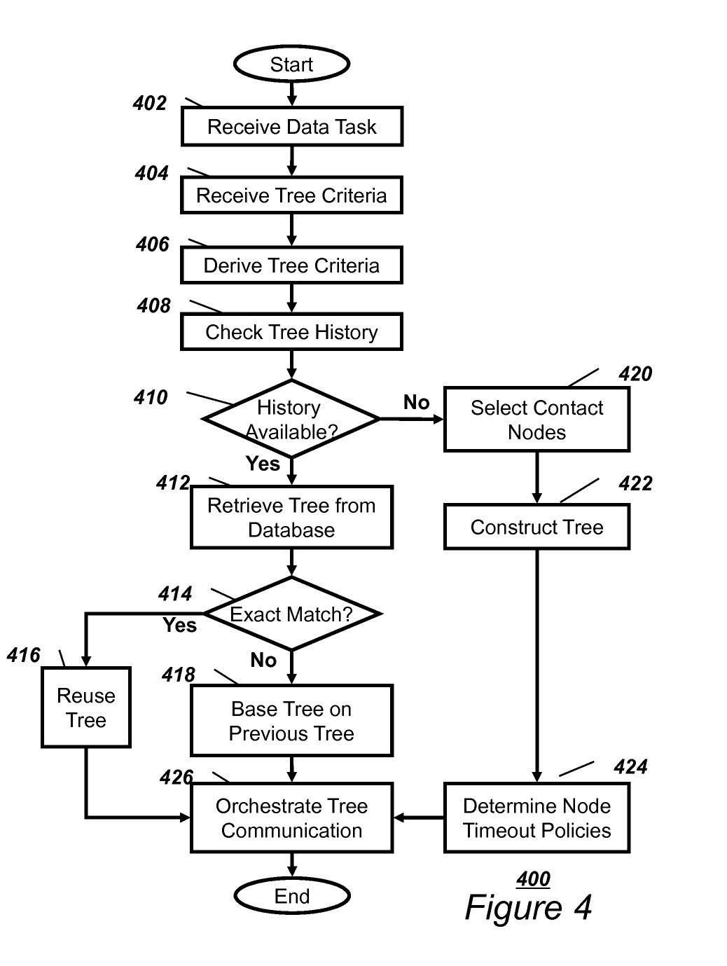

FIG. 4 illustrates in a flowchart one embodiment for a method 400 of constructing a hierarchical communications tree. The method 400 may use user preferences and node properties. The user preferences may include tree depth, layout, acceptable redundancy, node timeout, inclusion of a node, exclusion of a node or nodes, and other user preferences. The node properties may include presence, location, and other node properties. The tree designer 202 may receive a data task from a user (Block 402). The tree designer 202 may receive a set of tree criteria from the user (Block 404). The set of tree criteria may include contact nodes, tree depth, and other characteristics of the hierarchical communications tree. The goal generator 208 may derive a set of tree criteria based upon the data task if no criteria are provided by the user, or may derive a supplemental set of tree criteria in addition to any user provided set of tree criteria (Block 406). The tree designer 202 may then check the tree history database 206 (Block 408). If a tree matching a pre-defined percentage of the tree criteria is available in the tree history database 206 (Block 410), the tree designer 202 may retrieve the previously defined tree from the database (Block 412). The pre-defined percentage may be a default percentage, a percentage set by the user, an evolutionary percentage determined by the tree manager 200 to be optimum, or some other percentage. If the previously defined tree is an exact match to the set of tree criteria (Block 414), the tree designer 202 may reuse the previously defined tree (Block 416). If the previously defined tree is not an exact match to the set of tree criteria (Block 414), the tree designer 202 may construct a hierarchical communications tree based on the previously defined tree (Block 418).). If a tree matching a pre-defined percentage of the tree criteria is not available in the tree history database 206 (Block 410), the tree designer may select a sub-group of contact nodes from the group of contact nodes available through the node manager 204 based upon the data task (Block 420). The tree designer 202 may use the nodes to construct the hierarchical communications tree (Block 422). The position of a node in the group hierarchy may be determined based on the relative importance of the node for a given task as well as the acceptable redundancy. The tree designer 202 may determine node timeout policies based on the data task (Block 424). The timeout policies for each contact node may determine how long the process will wait for contact node response before continuing to the next available contact node in the tree. Based on a given tree and the associated timeout policies, the tree designer 202 may orchestrate the communication between the nodes (Block 420). The communication process may wait for a contact node response based on the timeout policies. The tree designer may manage the start, restart, and termination of the communication process. The tree designer 202 may report the dynamic state of the communication process to a tree manager.

Via the node manager 204, the tree designer 202 may have access to incremental knowledge about the completion status of the data task at hand, and use this information to guide the tree adaptation. The tree adaptation may be based on timeout status, stated goal, and knowledge state, and other metrics evaluating the effectiveness of the communication and performance of the data task. The tree adaptation may include tree optimization in terms of network flow, structure, and membership. For example, to meet the design goal new nodes may be dynamically added to the tree if one of the intermediate nodes does not respond. The tree adaptation method may be implemented as an evolutionary search, leveraging existing techniques, including genetic algorithms and tabu searches.

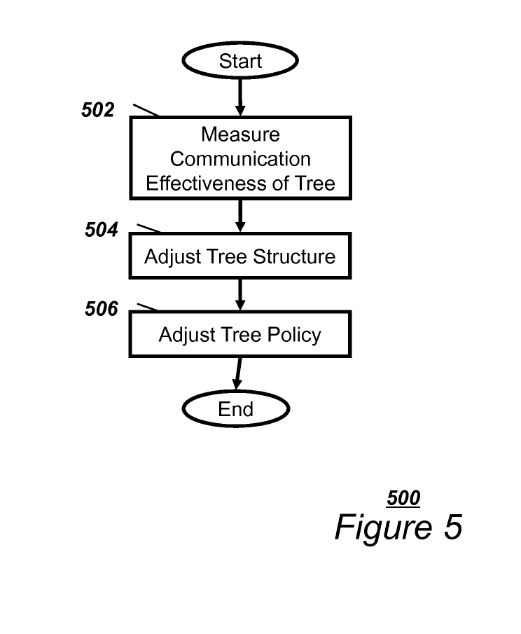

FIG. 5 illustrates in one embodiment a method 500 for adapting the hierarchical communications tree. The goal generator 208 may measure the communication effectiveness of a hierarchical communications tree (Block 502). The goal generator 208 may use an evaluation function, or a collection of logic and algebraic expressions, to evaluate the “fitness” of each candidate hierarchical communications tree and thereby compare alternative hierarchical communications trees. The goal generator 208 may create an instantiation of an evaluation function to be used for adapting a given tree. The tree designer 202 may adjust the tree structure in response to the measurements (Block 504). The tree designer 202 may adjust the tree policy, such as timeout length (Block 506). A candidate solution, or hierarchical communications tree, may be represented in terms of the constituent nodes, the interconnections, and the timeout values for each interconnection. Hash-table coding may be used to create identifiers for each of the nodes and associated interconnections. Timeout values may be on a pre-specified range.

The tree designer may use trees present in the tree history to “seed” a population of candidate solutions for an evolutionary search. The evaluation function may be used to guide the selection of the historical trees to be included in the set of candidate solutions. Likewise, new trees may be included in the set of candidate solutions. These may be generated by randomized changes, including swapping one node for another, changing the timeout value associated with the link between two nodes, and swapping one sub-tree for another.

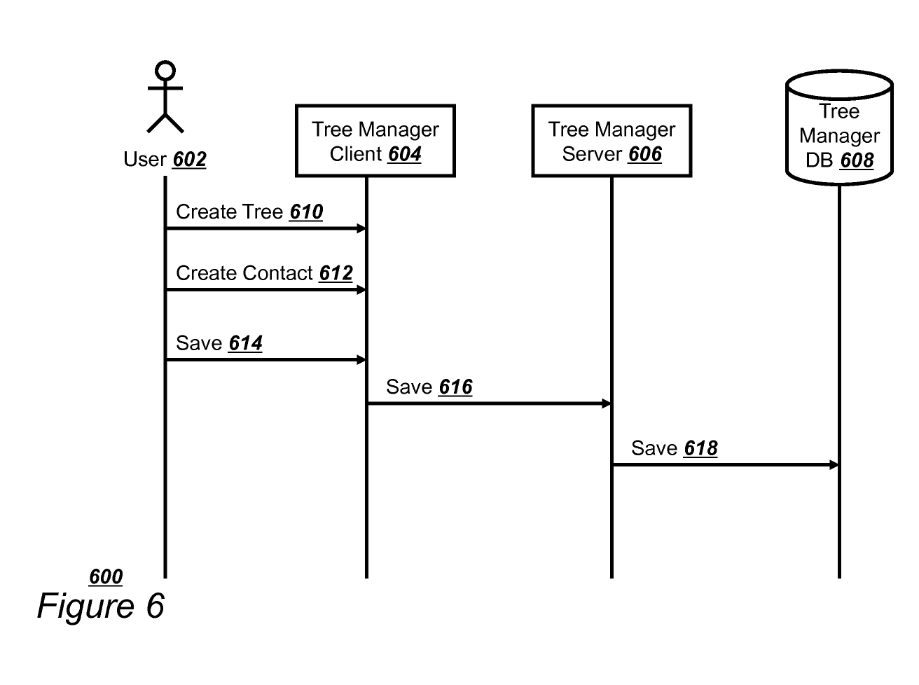

FIG. 6 illustrates one embodiment of a system 600 for creating a hierarchical communications tree. A user 602 may use a client telecommunication device with an instantiation of a client side tree manager 604. The client telecommunication device connects to a server, allowing the client side tree manager 604 to interact with a server side tree manager 606. The server side tree manager 606 may allow access to the tree manager database 608. The user 602 may create a hierarchical communications tree for the data task (Action 610). The user 602 may create a contact node to be added to the hierarchical communications tree (Action 612). The user may then save the completed hierarchical communications tree with the client side tree manager 604 (Action 614). The client side tree manager 604 may save the completed hierarchical communications tree with the server side tree manager 606 (Action 616). The server side tree manager 606 may save the completed hierarchical communications tree with the tree manager database 608 (Action 618).

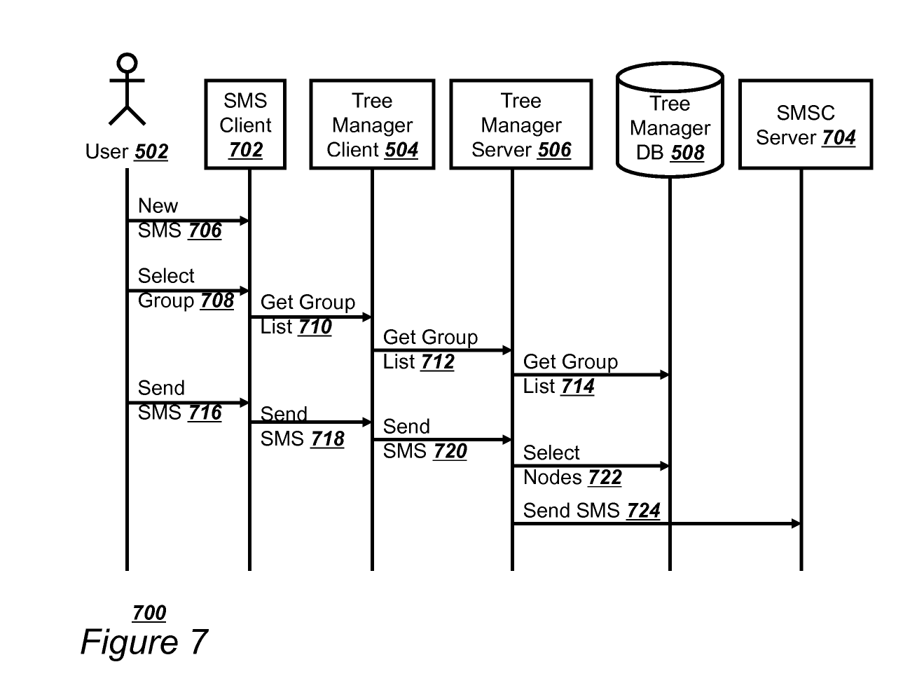

FIG. 7 illustrates one embodiment of a system 700 for sending a text message using a hierarchical communications tree. The user 602 may use a SMS client application 702 on a client telecommunication device to access a client side tree manager 604. The client telecommunication device connects to a server, allowing the client side tree manager 604 to interact with a server side tree manager 606. The server side tree manager 606 may allow access to the tree manager database 608. The server side tree manager 606 may also allow access to a short message server center (SMSC) server 704. The user 602 may create a new SMS message by entering a text message and a topic name (Action 706). The SMS client 702 may retrieve a set of groups for a given topic. The client 602 may select a group to send the message to (Action 708). The user 602 may also select the data task type, timeout length, and other hierarchical communications tree features. The SMS client 702 may retrieve a group list from the client side tree manager 604 (Action 710), having retrieved the group list from the server side tree manager 606 (Action 712). The server side tree manager 606 select the group list from the tree manager database 608 (Action 714). The user 602 may then input a SMS message and the selected group to the SMS client 702 (Action 716). The SMS client 702 may forward the SMS message and the selected group to the client side tree manager 604 (Action 718). The client side tree manager 604 may forward the SMS message and the selected group to the server side tree manager 606 (Action 720). The server side tree manager 606 may then select the nodes as part of the selected group from the tree manager database 508 (Action 722). The server side tree manager 606 may then send the SMS message to the selected contact nodes via the SMSC server 704 (Action 724).

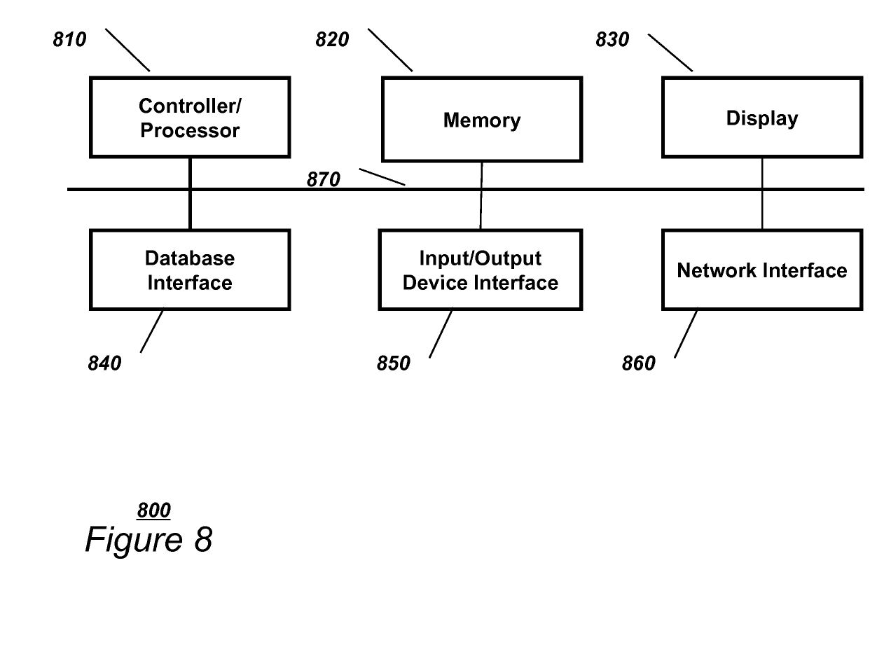

FIG. 8 illustrates a possible configuration of a computing system 800 to act as a mobile telecommunications apparatus or electronic device to execute the present invention. The computer system 800 may include a controller/processor 810, a memory 820, a display 830, a database interface 840, input/output device interface 850, and a network interface 860, connected through bus 870. The computer system 800 may implement any operating system, such as Microsoft Windows®, UNIX, or LINUX, for example. Client and server software may be written in any programming language, such as C, C++, Java or Visual Basic, for example. The server software may run on an application framework, such as, for example, a Java® server or .NET® framework

The controller/processor 810 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 820 may include volatile and nonvolatile data storage, including one or more electrical, magnetic or optical memories such as a random access memory (AM), cache, hard drive, or other memory device. The memory may have a cache to speed access to specific data. The memory 820 may also be connected to a compact disc—read only memory (CD-ROM, digital video disc—read only memory (DVD-ROM), DVD read write input, tape drive or other removable memory device that allows media content to be directly uploaded into the system.

The database interface 840 may be used by the controller/processor when executing the tree designer function 202 to access the tree history database 206. The node manager 204 may also use the database interface 840 to access a database storing the group of contact nodes. The tree history database 206 and the contact node may be stored locally on the telecommunications device or may be accessible through the network.

The Input/Output connection interface 850 may be connected to one or more input devices that may include a keyboard, mouse, pen-operated touch screen or monitor, voice-recognition device, or any other device that accepts input. The Input/Output connection interface 850 may also be connected to one or more output devices, such as a monitor, printer, disk drive, speakers, or any other device provided to output data. The Input/Output connection interface 850 may receive a data task from a user.

The network connection interface 860 may be connected to a communication device, modem, network interface card, a transceiver, or any other device capable of transmitting and receiving signals over a network. The network connection interface 860 may be used to connect a client device to a network. The network connection interface 860 may send and receive a data task as part of the operation of the tree manager, whether as a client or a server. The tree history database 206 and the contact node database may be accessed through the network interface. The components of the computer system 800 may be connected via an electrical bus 870, for example, or linked wirelessly.

Client software and databases may be accessed by the controller/processor 810 from memory 820, and may include, for example, database applications, word processing applications, as well as components that embody the decision support functionality of the present invention. The computer system 800 may implement any operating system, such as Microsoft Windows®, LINUX, or UNIX, for example. Client and server software may be written in any programming language, such as C, C++, Java or Visual Basic, for example. Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for hierarchical communications comprising:
receiving a data task;
selecting a sub-group of contact nodes from a group of contact nodes based upon the data task; and
creating with a tree manager a hierarchical communications tree from the sub-group of contacts based on the data task.

2. The method of claim 1, further comprising:
searching a tree history for a previously defined tree; and
basing the hierarchical communications tree on the previously defined tree.
The method of claim 1, further comprising:
basing the hierarchical communications tree on a set of tree criteria.

4. The method of claim 3, further comprising:
deriving the set of tree criteria based on the data task.

5. The method of claim 3, further comprising:
receiving the set of tree criteria from a user.

6. The method of claim 3, wherein the set of tree criteria includes at least one of a number of contact nodes, tree depth, tree breadth, total interconnections, average number of sub-nodes connected to a root node.

7. The method of claim 1, further comprising:
adjusting the hierarchical communications tree based on a metric evaluating performance of the data task.

8. The method of claim 1, further comprising:
sending a communication to the sub-group of contact nodes regarding the data task using the hierarchical communications tree.

9. The method of claim 8, wherein the communication is a text message.

10. A telecommunications apparatus for hierarchical communications comprising:
a connection interface that receives a data task;
a database that stores a group of contact nodes;
a processor that selects a sub-group of contact nodes from the group of contact nodes based upon the data task and creates a hierarchical communications tree from the sub-group of contacts based on the data task.

11. The telecommunications apparatus of claim 10, wherein the processor searches a tree history for a previously defined tree and bases the hierarchical communications tree on the previously defined tree.

12. The telecommunications apparatus of claim 10, wherein the processor bases the hierarchical communications tree on a set of tree criteria.

13. The telecommunications apparatus of claim 12, wherein the processor derives the set of tree criteria based on the data task.

14. The telecommunications apparatus of claim 12, wherein the processor receives from a user the set of tree criteria.

15. The telecommunications apparatus of claim 12, wherein the set of tree criteria includes at least one of a number of contact nodes, tree depth, tree breadth, total interconnections, average number of sub-nodes connected to a root node.

16. The telecommunications apparatus of claim 10, wherein the processor adjusts the hierarchical communications tree based on a metric evaluating performance of the data task.

17. The telecommunications apparatus of claim 10, wherein the processor sends a communication to the sub-group of contact nodes regarding the data task using the hierarchical communications tree.

18. The telecommunications apparatus of claim 17, wherein the communication is a text message.

19. An electronic device for hierarchical communications comprising:
a connection interface that receives a data task;
a database that stores a group of contact nodes;
a processor that selects a sub-group of contact nodes from the group of contact nodes based upon the data task and creates a hierarchical communications tree from the sub-group of contacts based on the data task.

20. The electronic device of claim 19, wherein the processor adjusts the hierarchical communications tree based on a metric evaluating performance of the data task.
